(19) United States
(12) Patent Application Publication
(10) Pub. No.: US 2002/0069631 A1
(43) Pub. Date: Jun. 13, 2002

(54) Vegetation cutter having vortex inducing blade system

(76) Inventors: Colin Dyke, North Augusta (CA); William R. Lessig III, Monkton, MD (US); David J. Doss, Glen Burnie, MD (US); Gerald R. Rescigno, Marriottsville, MD (US)

Correspondence Address: Harness, Dickey & Pierce, P.L.C., P.O. Box 828, Bloomfield Hills, MI, 48303, US

(21) Appl. No.: 09/736,838

(22) Filed: Dec. 13, 2000

(51) Int. Cl. A01D 34/416; A01D 34/68

(52) U.S. Cl. 56/17.5; 56/12.7

(57) ABSTRACT

A vegetation cutter having a mulching blade system including a cutting blade and an independent vortex inducing blade. The cutting blade performs no vortex inducing function but rather only operates to cut vegetation. The vortex inducing blade is designed strictly to provide vortices at the outer ends thereof, and does not perform any cutting function. The vortices operate to even more effectively suspend vegetation trimmings within a volute cutting chamber of a deck of the vegetation cutter such that the trimmings can be cut several times by the cutting blade before being deposited back into the vegetation over which the cutter is traversing.

### TECHNICAL FIELD

This invention relates to Vegetation Cutters such as mulching lawn mowers, and more particular to a mulching lawn mower incorporating a cutting blade and an independent vortex inducing blade for more effectively suspending vegetation clippings within a cutting chamber of the mower deck to thereby more effectively mulch the vegetation clippings.

### BACKGROUND OF THE INVENTION

Vegetation cutters such as mulching lawn mowers have gained increasing popularity in recent years. Mulching lawn mowers attempt to cut vegetation trimmings numerous times before the trimmings are deposited back into the lawn being cut. Mulching mowers are seen as even more environmentally friendly than conventional side discharge mowers (ie, non-mulching mowers) because the mulched vegetation clippings are pushed back down into the lawn being cut and thus serve as natural/organic fertilizer.

With mulching mowers, the goal is to have the cutting blade cut the vegetation trimmings a plurality of times so that the trimmings are very small in size, and therefore easily assimilated back into the lawn being cut. Traditional mulching mowers have attempted to accomplish this with the use of a single cutting blade. Often, the cutting blade is formed with a complex shape in an attempt to generate some form of swirling airflow within the mower deck. The swirling airflow is desirable for suspending the freshly cut vegetation trimmings within the mower deck for a longer period of time so that the trimmings can be recut several times before being deposited back into the lawn. Such one piece blade designs must be formed as a compromise between a cutting element and an airflow generating element. The result of this compromise is increased drag which results in increased energy consumption. It is believed that even further improvements in the ability of a blade system to suspend the freshly cut vegetation trimmings are possible if a blade was provided which was designed strictly to create the desired vortices needed to generate the lifting vortex airflow within the deck.

It is further believed that a mulching blade system which even more effectively mulches the freshly cut vegetation trimmings will also require less power than otherwise required for mowers with conventional mulching blade systems. The requirement of less power would mean that slightly less powerful, and less expensive, motors would be required to drive the mulching blade system. It would also mean that other features, such as self propulsion, could be added. Also, a decrease in energy consumption would provide additional run time for cordless mowers.

Accordingly, it is a principal object of the present invention to provide a mulching blade system for a vegetation trimmer which incorporates a cutting blade dedicated to performing strictly a cutting action, and an independent vortex generating blade which is used strictly to generate a vortex in the volute chamber of a cutting deck of a vegetation trimmer to thus optimize the suspension of freshly cut vegetation clippings.

It is another object of the present invention to provide a mulching blade system for a mower which makes use of an independent cutting blade for cutting vegetation, and an independent vortex generating blade which is driven concurrently with the cutting blade by a motor of the vegetation trimmer, and which operates to even more efficiently generate vortices within a volute cutting chamber of a mower deck to thereby enable partially cut vegetation trimmings to be better suspended within the volute cutting chamber to promote even more efficient mulching of the trimmings.

It is still another object to the present invention to provide a mulching blade system for a vegetation cutting such as a mulching lawn mower, where the mulching blade system incorporates an independent cutting blade and independent vortex generating blade, and where each of the two blades can be secured to a single output shaft of a motor used to drive the cutting blade system without significantly increasing the cost or complexity of the mower, and without altering the design of the deck of the mower.

### SUMMARY OF THE INVENTION

The above and other objects are provided by a vegetation cutter having a vortex generating blade system in accordance with preferred embodiments of the present invention. In one preferred embodiment the present invention incorporates a blade system disposed within a deck of a vegetation cutter, where the blade system is driven rotationally by a motor disposed on the deck. The blade system includes a cutting blade secured to an output shaft to the motor and an independent, vortex generating blade which is also secured to the output shaft. The cutting blade includes no features for modifying the airflow or for creating vortices within a volute cutting chamber of the mower deck; this function is dedicated strictly to the vortex generating blade. The vortex generating blade operates to create vortices at its outer ends which help to suspend freshly cut vegetation trimmings within the volute cutting chamber area of the deck. The strong, swirling vortices allow the freshly cut vegetation trimmings to be suspended for a longer period of time, thus causing the clippings to be cut numerous times by the cutting blade before the clippings are deposited back into the vegetation being traversed by the vegetation cutter.

In one preferred form, the cutting blade comprises a flat blade. In one preferred form, the vortex inducing blade comprises a shape similar to a helicopter rotor. The cross-sectional shape and angle of inclination of this blade causes a low pressure area to be formed along its upper surface and a high pressure area to be formed along its lower surface. This causes strong vortices to be generated at its outer ends which create a strong, swirling force. The swirling force helps to suspend the freshly cut clippings within the volute cutting chamber of the deck.

Since the vortex inducing blade performs no cutting function, its geometry and design can be tailored specifically for producing highly efficient vortices. Conversely, since the cutting blade is not required to perform any vortex generating function, its design can be tailed for maximum cutting efficiency.

The blade system of the present invention does not require significant modifications to the deck of the vegetation cutter and does not add significant additional cost to the vegetation cutter, or significantly increase the overall complexity of its construction.

### BRIEF DESCRIPTION OF THE DRAWINGS

The various advantages of the present invention will become apparent to one skilled in the art by reading the following specification and subjoined claims and by referencing the following drawings in which:

FIG. 1 is a perspective view of a vegetation cutter in the form of a mulching lawn mower which incorporates the vortex inducing blade system of the present invention;

FIG. 2 is a simplified cross-sectional side view of the mower deck with the cutting blade and vortex inducing blade shown disposed within the cutting deck;

FIG. 3 is a plan view of just the cutting blade and the vortex inducing blade, taken in accordance with section line 3-3 in FIG. 2;

FIG. 4 is a perspective view of the cutting blade;

FIG. 5 is a side view of the vortex inducing blade;

FIG. 6 is a front view of the vortex inducing blade of FIG. 5 taken in accordance with directional arrow 6 in FIG. 5 illustrating the wing tip vortices created at each end of the vortex inducing blade;

FIG. 7 is a view of the wing tip vortices created within the volute cutting chamber of the deck illustrating how freshly cut vegetation trimmings are suspended within the cutting chamber to ensure that the trimmings are cut multiple times before being deposited back into the vegetation over which the mower is traversing;

FIG. 8 is a side view of a vortex created at one end of the vortex generating blade; and

FIG. 9 is a side view of the vortex shown in FIG. 8 after the vortex has grown and its center has moved out into the center of the volute cutting chamber.

### DETAILED DESCRIPTION OF THE PREFERRED EMBODIMENTS

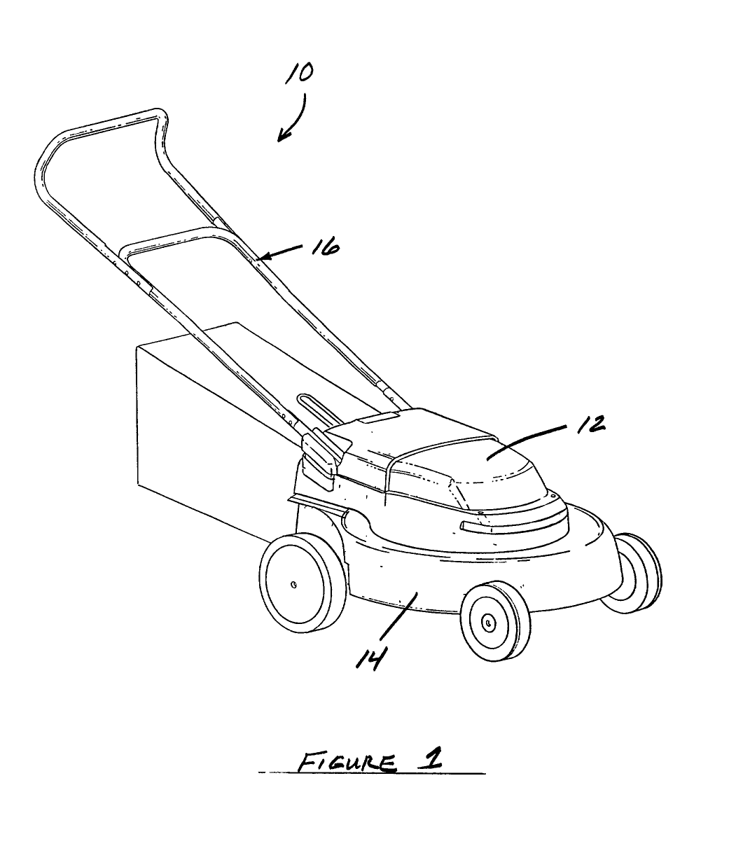

Referring to FIG. 1, there is shown a vegetation trimmer in the form of a lawn mower 10. The lawn mower 10 includes an electric motor disposed under a shroud and supported on a deck 14 of the mower 10. The handle assembly 16 is used to guide the mower over vegetation being trimmed. It will be appreciated that while the lawn mower 10 is illustrated as a walk behind mower, that the teachings of the present invention are applicable to any form of vegetation cutting apparatus that is required to cut vegetation clippings with a mulching-type action, and whether such apparatus comprises a walk-behind or a riding vegetation cutter.

Referring to FIG. 2, the deck 14 can be seen in greater detail. The deck 14 includes a volute cutting chamber 18 within which is disposed a mulching blade system 20 in accordance with a preferred embodiment of the present invention. The deck supports a motor, which in one form may comprise an electric motor 22 having an output shaft 24 for driving the blade system 20. Alternatively, a gasoline powered engine could just as readily be employed. The blade system 20 comprises a cutting blade 26 fixedly coupled to the output shaft 24 and a vortex inducing blade 28 which is also fixedly coupled to the output shaft 24.

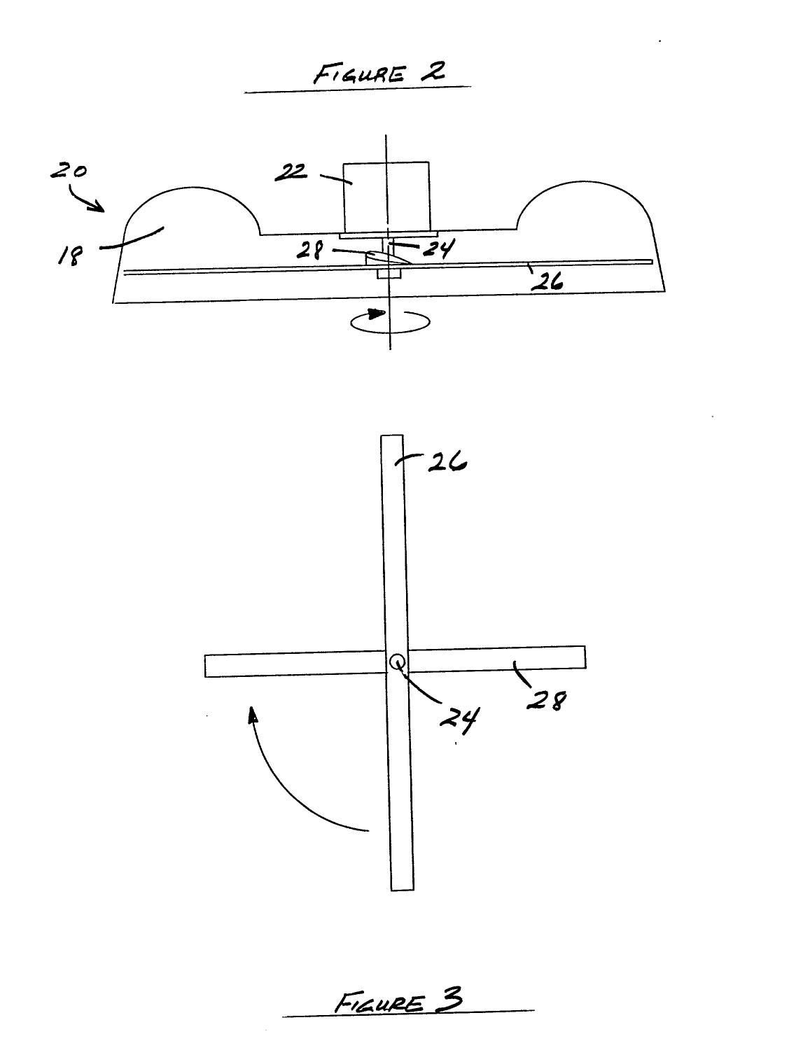

With brief reference to FIG. 3, the vortex inducing blade 28 can be seen to be slightly shorter in length than the cutting blade 26. The vortex inducing blade 28 is shorter to provide room for the vortices at each end of the blade to move outwardly and grow so that the vortices are centered in the path of the cutting blade 26. The vortex inducing blade 28 also is disposed above the cutting blade 26 to better help draw vegetation clippings into the cutting path of the cutting blade 26.

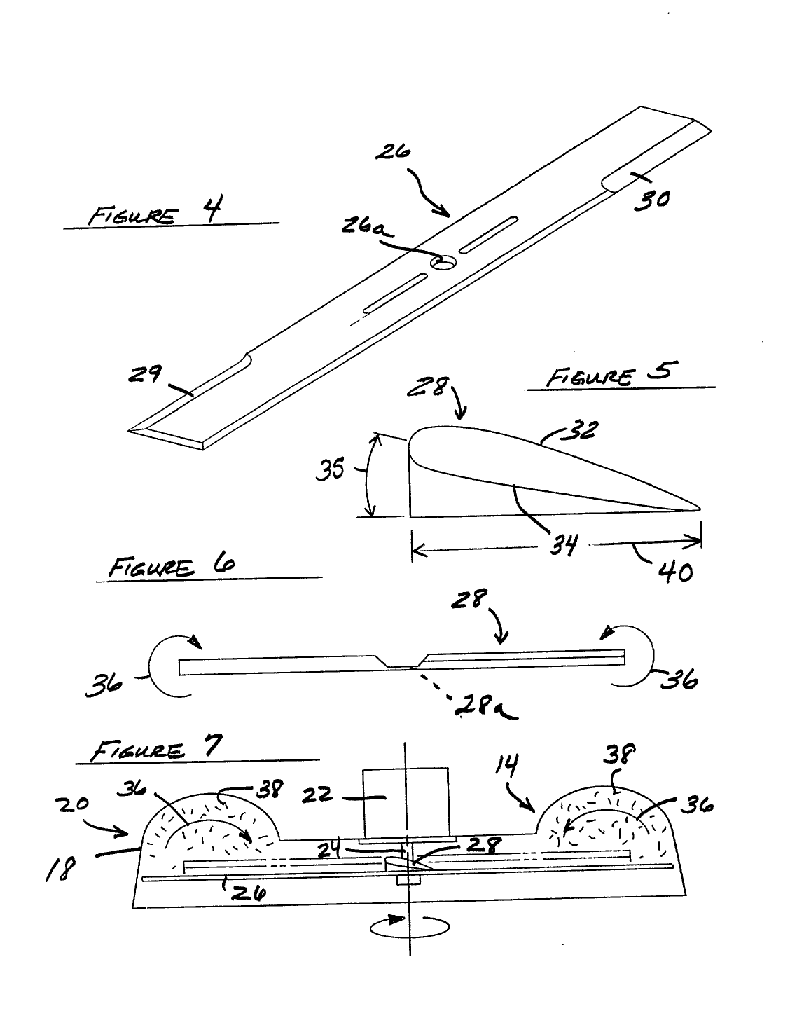

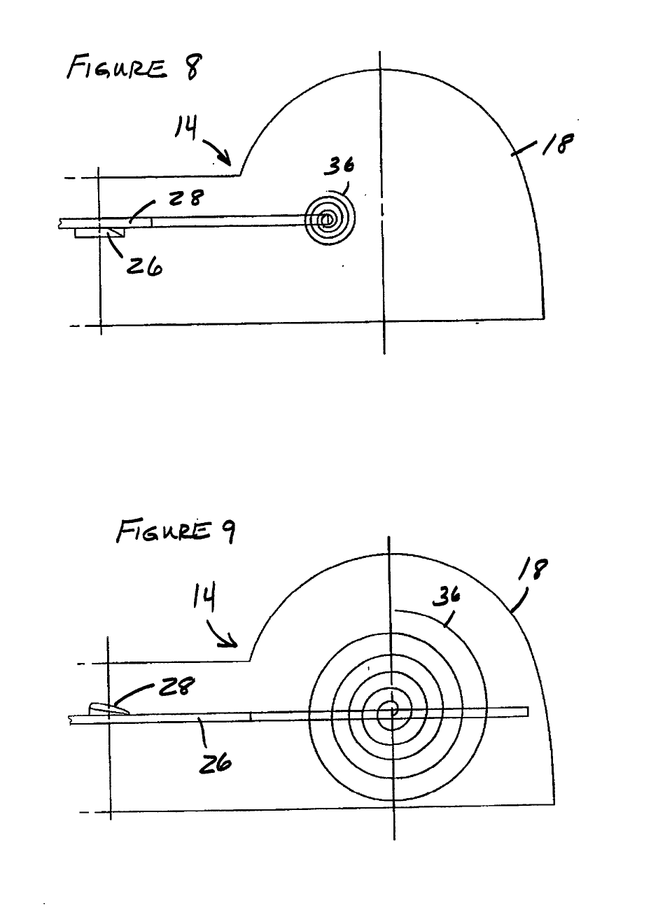

In FIG. 4, the cutting blade 26 is shown in greater detail. The cutting blade 26 has outermost cutting edge surfaces 29 and 30 at opposite ends thereof and an opening 26a to accept the output shaft 24 of the motor 22. It will be appreciated, however, that a cutting line or filament could be used to form the cutting blade 26. Since the cutting blade 26 is not required to perform any vortex inducing function, it can be formed as a simple planar component.

Referring to FIG. 5, the vortex inducing blade 28 is illustrated. This blade comprises a cross sectional shape which provides a low pressure area along an upper surface 32 and a high pressure area along a lower surface 34. It includes an angle of inclination of preferably about 100, as indicated by angle 35. In one preferred form the cross sectional shape of the blade 28 is generally in accordance with a NACA 0012 blade used on many helicopters. An E395 profile blade used on sail planes could also be used.

With reference to FIG. 6, the outermost ends of the vortex inducing blade 28 operate to generate vortices 36 when the blade 28 is driven rotationally by the motor 22. An opening 28a accepts the output shaft 24. Each of the blades 26 and 28 are secured fixedly to the output shaft 24 of the motor 22.

Referring to FIG. 7, during operation of the mower 10 the vortex inducing blade 28 creates the vortices 36 which operate to lift and suspend freshly cut vegetation clippings 38 within the volute cutting chamber 18 of the deck 14. With reference to FIGS. 8 and 9, the vortices 36 are created at the opposing ends of the blade 28. Thereafter the center of each vortex 36 moves outward and grows, as indicated in FIG. 9. Each vortex 36 moves into the cutting path of the cutting blade 26 just prior to the cutting blade passing through it. As a result of being suspended in the swirling vortices 36, the vegetation clippings 38 are caused to be cut several additional times by the cutting blade 26 before being deposited into the vegetation over which the mower 10 is travelling.

It is a principal advantage of the present invention that by using a two blade system rather than a single blade system, the shape of the vortex inducing blade 28 can be formed to maximize its vortex inducing capability. An additional advantage of the two blade design is that the cutting blade 26, not being required to perform any vortex inducing function, can be designed simpler and to optimize its cutting ability. Advantageously, the two blade system does not significantly increase the cost of the mower 10 nor significantly increase its complexity of construction. The dual blade system 20 thus produces an extremely effective mulching action which helps the vegetation clippings to be assimilated back into a lawn or other area of vegetation being cut.

The cutting blade 26 may be formed from steel, a composite polymer or any other suitably strong material. The vortex inducing blade 28 is also preferably formed from steel, a composite polymer or another suitably strong material and has a maximum width, defined by dimensional arrow 40 in FIG. 5, of preferably between about 20 mm-60 mm. The vortex inducing blade 28 also has a thickness of preferably between about 2.0 mm-6.0 mm, and more preferably about 5 mm. It will be appreciated, however, that these dimensions could vary to suit the needs of a specific application.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and following claims.

What is claimed is:

1. A vegetation cutter comprising:
a deck:
a motor supported on said deck and an output shaft extending through an opening in said deck into a volute of said deck;
a cutting blade coupled to said output shaft of said motor for cutting vegetation when driven rotationally by said motor; and
a vortex inducing blade coupled to said output shaft for generating vortices at opposite ends thereof when driven rotationally by said motor, said vortices operating to help suspend vegetation clippings cut by said cutting blade within said volute so that said vegetation clippings are cut a plurality of times by said cutting blade.

2. The vegetation cutter of claim 1, wherein said cutting blade comprises a cutting filament.

3. The vegetation cutter of claim 1, wherein said vortex inducing blade comprises a profile in accordance with a NACA 0012 helicopter blade.

4. The vegetation cutter of claim 1, wherein said vortex inducing blade comprises a profile in accordance with an E395 sail plane profile.

5. The vegetation cutter of claim 1, wherein said vortex inducing blade comprises a width of between about 20 mm-60 mm.

6. The vegetation cutter of claim 1, wherein said vortex inducing blade comprises a width of about 45 mm.

7. The vegetation cutter of claim 1, wherein said vortex inducing blade comprises a maximum thickness of between about 5 mm.

8. A vegetation cutter comprising:
a deck having a volute cutting chamber:
a motor supported on said deck and having an output shaft extending through an opening in said deck into said volute cutting chamber of said deck;
a cutting blade coupled to said output shaft and disposed within said volute cutting chamber for cutting vegetation when driven rotationally by said motor; and
a vortex inducing blade disposed within said volute cutting chamber and coupled to said output shaft above said cutting blade for generating vortices at opposite ends thereof when driven rotationally by said motor, said vortices operating to help suspend vegetation clippings cut by said cutting blade within said volute so that said vegetation clippings are cut a plurality of times by said cutting blade before being deposited into said vegetation over which said vegetation cutter is traversed.

9. The vegetation cutter of claim 8, wherein said cutting blade comprises a cutting filament.

10. The vegetation cutter of claim 8, wherein said vortex inducing blade comprises a cross-sectional profile in accordance with a NACA 0012 helicopter blade profile.

11. The vegetation cutter of claim 8, wherein said vortex inducing blade comprises a width of between about 30 mm-60 mm.

12. The vegetation cutter of claim 8, wherein said vortex inducing blade comprises a width of about 45 mm.

13. The vegetation cutter of claim 8, wherein said vortex inducing blade comprises a maximum thickness of between about 3-6 mm.

14. The vegetation cutter of claim 8, wherein said vortex inducing blade comprises a maximum thickness of about 5 mm.

15. A method for mulching vegetation clippings within a volute cutting chamber of a deck of a vegetation cutter, said method comprising the steps of:
using an independent cutting blade disposed within said volute cutting chamber, and driven by a motor of said vegetation cutter, to cut said vegetation clippings; and
using an independent vortex inducing blade disposed within said volute cutting chamber, and driven by said motor, to create vortices at outer ends of said vortex inducing blade to cause freshly cut vegetation clippings to be cut a plurality of times before being deposited back into vegetation over which said vegetation cutter traverses.
